(19) United States
(12) Patent Application Publication
(10) Pub. No.: US 2017/0329878 A1
(43) Pub. Date: Nov. 16, 2017

(54) VARIABLE DENSITY MODELING

(71) Applicant: Hewlett- Packard Development Company, L.P., Houston, TX (US)

(72) Inventors: Jay S. Gondek, Camas, WA (US); Stephen J. Nichols, Vancouver, WA (US); Peter Morovic, Sant Cugat del Valles (ES); Jan Morovic, Colchester (GB); William J. Allen, Corvallis, OR (US)

(21) Appl. No.: 15/523,293

(22) PCT Filed: Jan. 30, 2015
(86) PCT No.: PCT/US2015/013684

§ 371 Date: Apr. 28, 2017

(51) Int. Cl. G06F 17/50; B33Y 50/00; B29C 64/386

(52) U.S. Cl. CPC G06F 17/5009; B29C 64/386; B33Y 50/00; G06F 2217/16

(57) ABSTRACT

Variable density modeling can, in an example implementation, include an error tracking tree data structure of a variable density three-dimensional (3-D) object to be additively manufactured and an open voxel tracking tree data structure of the 3-D object.

### BACKGROUND

Additive manufacturing can use a mechanism to successively deposit a material to build up a three-dimensional (3-D) object. 3-D printing can be one such mechanism of additive manufacture. 3-D printed objects may be created with a single material at a fixed high density.

### BRIEF DESCRIPTION OF THE DRAWINGS

FIG. 1 illustrates a diagram of an example of a system for variable density modeling according to the present disclosure.

FIG. 2 illustrates a diagram of an example of a computing device according to the present disclosure.

FIG. 3 illustrates an example of an environment suitable for variable density modeling according to the present disclosure.

FIG. 4 illustrates a flow chart of an example of a method for variable density modeling according to the present disclosure.

### DETAILED DESCRIPTION

Additive manufacturing techniques including three-dimensional (3-D) printing have gained acceptance for its ability to rapidly reproduce high-quality parts from computer-aided design (CAD) specifications. Improved additive manufacturing techniques enable the production of increasingly sophisticated objects.

Unlike some models that may represent a single material at a fixed density (e.g., a high density), examples of the present disclosure describe a system, method, and computer readable medium for variable density modeling. Desirably, variable density modeling can employ multiple materials and/or utilize various densities when modeling an object. For example, variable density modeling can include an error tracking tree data structure of a variable density three-dimensional (3-D) object to be additively manufactured and an open voxel tracking tree data structure of the 3-D object.

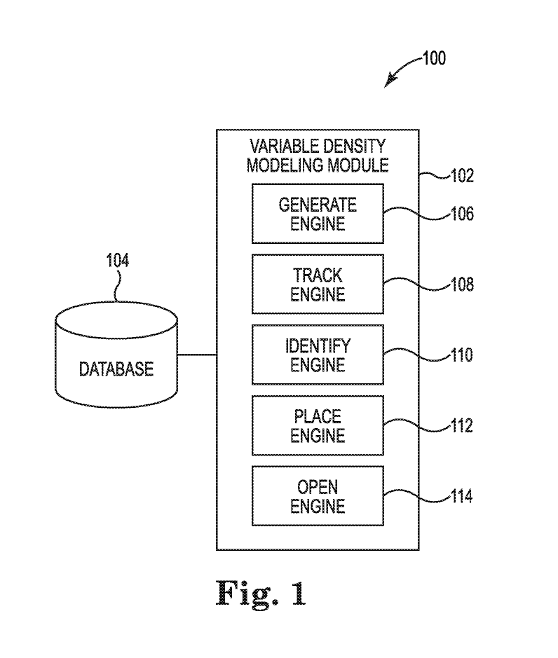

FIG. 1 illustrates a diagram of an example of a system 100 for variable density modeling according to the present disclosure. The system can include a database 104, a variable density modeling manager 102, and/or a number of engines (e.g., generate engine 106, track engine 108, identify engine 110, place engine 112, open engine 114). The variable density modeling manager 102 can be in communication with the database 104 via a communication link, and can include the number of engines (e.g., generate engine 106, track engine 108, identify engine 110, place engine 112, open engine 114). The variable density modeling manager 102 can include additional or fewer engines than are illustrated to perform the various functions as will be described in further detail.

The number of engines (e.g., generate engine 106, track engine 108, identify engine 110, place engine 112, open engine 114) can include a combination of hardware and programming, but at least hardware, that is to perform functions described herein (e.g., generate an error tracking tree data structure of a 3-D object, generate an open voxel tracking octree model of the 3-D object, identify an open voxel with a comparatively largest error, etc.). The programming can include program instructions (e.g., software, firmware, etc.) stored in a memory resource (e.g., computer readable medium, machine readable medium, etc.) as well as hard-wired programs (e.g., logic).

The generate engine 106 can include hardware and/or a combination of hardware and programming, but at least hardware, to generate an error tracking tree data structure of a variable density 3-D object (e.g., a 3-D object having various densities at respective portions thereof) to be additively manufactured. Unlike other approaches that employ sequential error diffusion or matrix-based dithering, the generate engine 106 can utilize a random-access formula that can utilize a multi-scale error representation to track errors for voxels and larger regions of an object (e.g., an input targeted object model).

As used herein, a voxel can refer to a smallest addressable location of a 3-D object addressable by an additive manufacturing device. In some examples, a voxel can be one millimeter square or smaller. The voxel can correspond to a point on a 3-D object computer-aided design model or a conversion thereof to a compatible format. A voxel can include a highest resolution point, as described herein, where an additive manufacturing device can place a material.

As used herein, an error can be defined as an amount of material remaining to be placed, for instance, expressed as a probability of placement of the material at a particular location (e.g., a voxel). For example, at a particular location of a 3-D object the target density fill (e.g., a designated density of material to be placed at particular location of the 3-D object) can be ninety percent material density. The corresponding probability that the particular location will be filled by placement an element to satisfy the density fill designation can, therefore, be ninety percent and/or nine tenths. In this example, the error for that location can be ninety percent and/or nine tenths. As used herein, an element can be an amount of material or an indication of an amount of material (e.g., quantity of material, presence of material, absence of material, etc.) to be placed in a location (e.g., a physical location on an additive manufacturing device build space, a virtual location of a model of a 3-D object, etc.). As used herein, the material can refer to a physical material. The material can include a liquid material. For example, material can refer to a liquid agent (e.g., an energy absorbing fusing agent) applied to a curable material (e.g., a thermoplastic powder, etc.). In some examples (e.g., material deposition systems) the material can be a solid and/or gel material.

The error tracking tree data structure can identify, assign, monitor, mathematically manipulate (e.g., convert the values utilizing a mathematical function, add the values, etc.) and/or store these error values and represent them in a tree data structure. The tree data structure can include a data structure made up of a partitioned 3-D object model. For example, the 3-D object model can be recursively subdivided into cells corresponding to portions of the partitioned 3-D object model at various resolutions. For example, the error tracking tree data structure can include a plurality of cells corresponding to a highest resolution of the partitioned 3-D object model (e.g., bottom level cells). In some example, the highest resolution can include a single voxel-level error resolution. That is, the highest resolution can include an error of a cell representing a single voxel portion of the partitioned 3-D object model. In further examples, error tracking tree data structure can include a cell corresponding to a lowest resolution of the partitioned 3-D object model (e.g., a top level cell). The lowest resolution can include a sum of the remaining errors of the plurality of bottom level cells corresponding to a highest resolution of the partitioned 3-D object model. Since, as described above, the error can correspond to the material remaining to be placed to satisfy a target density fill designation, the sum of the remaining errors of the plurality of bottom level cells of the partitioned 3-D object model can correspond to the total amount of material remaining to be placed for the 3-D object. The error tracking tree data structure can have multiple levels of resolution. That is, the error tracking tree data structure can have multiple distinct cells/groups of cells that correspond to multiple different levels of resolution between the cells corresponding to the highest and lowest resolutions. For example, the error tracking tree data structure can include distinct cells/groups of cells that correspond to each of the recursive subdivisions of the 3-D object model and each of these cells/groups of cells can be a distinct resolution level of the 3-D object model. The error tracking tree data structure can be an error tacking octree model.

The track engine 108 can include hardware and/or a combination of hardware and programming, but at least hardware, to generate an open voxel tracking tree data structure for the 3-D object. Unlike other approaches that employ sequential error diffusion, the generate engine 108 can define, place within a 3-D object model, track, and manipulate voxels (and their corresponding locations within a 3-D object) and their availability for material placement. The open voxel tracking tree data structure can be an open voxel tracking octree model.

The tree data structure can include a data structure (e.g., octree model) made up of a partitioned 3-D object model. The tree data structure (e.g., octree model) can include the structure discussed above with reference to generate engine 106. The tree data structure (e.g., octree model) can be the same tree data structure used by generate engine 106, a tree data structure (e.g., octree model) merged and/or corresponding to the tree data structure (e.g., octree model) used by generate engine 106, and/or a separate tree data structure (e.g., octree model) from that used by generate engine 106.

As used herein, an open voxel can include a voxel that is available to receive an element. That is, an open voxel can include a voxel that is available for material placement (e.g., a liquid agent to be applied to a curable powder on a build area). As used herein, a closed voxel can include a voxel that is not available to receive an element. That is, a closed voxel can include a voxel that is not available for material placement. A voxel can be designated as open or closed by the 3-D object model and/or be designated as open or closed based on a determination by the generate engine 108. For example, for dispersed-dot halftoning (e.g., scattering the smallest available dots/portions of a 3-D object in a random or pseudorandom manner to create varying densities) voxels with a target density fill greater than zero as tracked in the open voxel tracking tree data structure can be defined as open. In further examples, connectivity among placed elements can be enforced by controlling the distribution of open voxels, designations of voxels to be filled, and/or context aware element placement in a 3-D object model (e.g., biasing element placement to create local connections among voxels, building by placing voxels toward regions of high error, etc.) within the tree data structure.

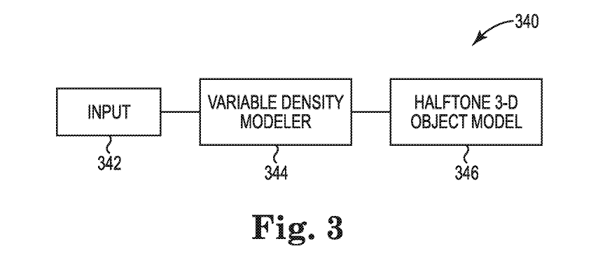

The identify engine 110 can include hardware and/or a combination of hardware and programming, but at least hardware, to identify an open voxel with a comparatively largest error for placement of an element to form at least a portion of the 3-D object. To place a single element, the error tracking tree data structure (e.g., octree model) and the open voxel tree data structure (e.g., octree model) for the 3-D object can be searched. The search can be a randomized search of the cells of the partitioned 3-D object model of the error tracking tree data structure (e.g., octree model) and the open voxel tree data structure (e.g., octree model) to produce a better distribution of the resulting placed elements. As part of this search, the identify engine 110 can identify an open voxel with a comparatively largest error. This identification can be made via an examination of the error of voxels from the error tracking tree data structure (e.g., octree model). Further, the identify engine 110 can identify a voxel with a designation of availability for the material being placed. This identification can be made via an examination of such information tracked in the open voxel tracking tree data structure (e.g., octree model), as discussed in further detail below in connection with FIG. 3.

The place engine 112 can include hardware and/or a combination of hardware and programming, but at least hardware, to place the element in the open voxel and update the error tracking tree data structure (e.g., octree model) and the open voxel tracking tree data structure (e.g., octree model) to reflect the placement. For example, the error tracking tree data structure (e.g., octree model) and the open voxel tracking tree data structure (e.g., octree model) can be updated by marking the open voxel at which an element was placed as closed.

The open engine 114 can include hardware and/or a combination of hardware and programming, but at least hardware, to open and/or close voxels in the 3-D object. The determination to open or close a voxel can be based on the targeted density fill for the voxel and/or adjacent voxels, the tracked error for the voxel and/or adjacent voxels, a desired connectivity for the voxel and/or between the voxel and adjacent voxels, a designation of acceptable material type for the voxel and/or adjacent voxels, the placement of an element in a voxel/adjacent voxel, and/or combinations thereof. For example, the open engine 114 can deterministically open and/or close cells during execution of an error diffusing operation. As an example, the open engine may open a voxel adjacent to a voxel designated as containing a placed element to enforce connectivity between the two voxels. As used herein, enforcing connectivity can include identification of and/or opening or closing of voxels in a manner resulting in a connected 3-D object. That is, enforcing connectivity can include designating adjacent voxels as open so that the placed material(s) within the voxels will physically connect in the additively manufactured 3-D object.

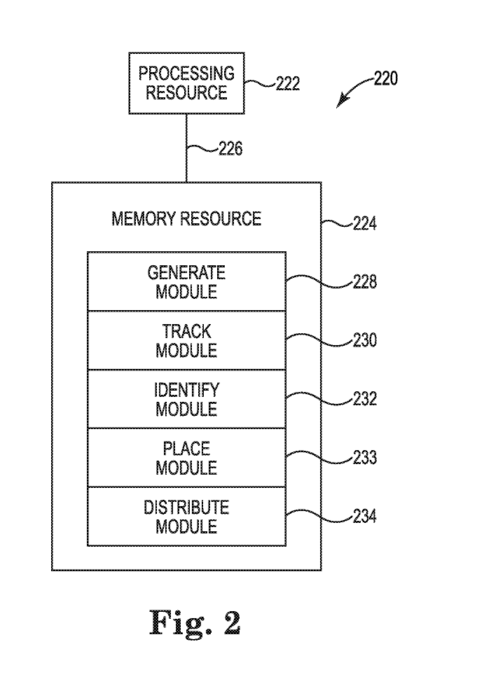

FIG. 2 illustrates a diagram of an example of a computing device 220 according to the present disclosure. The computing device 220 can utilize software, hardware, firmware, and/or logic to perform functions described herein.

The computing device 220 can be any combination of hardware and program instructions to share information. The hardware, for example, can include a processing resource 222 and/or a memory resource 224 (e.g., non-transitory computer-readable medium (CRM), machine readable medium (MRM), database, etc.). A processing resource 222, as used herein, can include any number of processors capable of executing instructions stored by a memory resource 224. Processing resource 222 can be implemented in a single device or distributed across multiple devices. The program instructions (e.g., computer readable instructions (CRI)) can include instructions stored on the memory resource 224 and executable by the processing resource 222 to implement a desired function (e.g., generate an error tracking octree model of a 3-D object to be additively manufactured; generate an open voxel tracking octree model for the 3-D object; identify a plurality of open voxels with respective errors; place a plurality of elements at the plurality of open voxels to form at least a portion of the 3-D object; distribute the placement of the plurality of elements to achieve a particular distribution using a plurality of density-dependent error kernels; etc.).

The memory resource 224 can be in communication with the processing resource 222 via a communication link (e.g., a path) 226. The communication link 226 can be local or remote to a machine (e.g., a computing device) associated with the processing resource 222. Examples of a local communication link 226 can include an electronic bus internal to a machine (e.g., a computing device) where the memory resource 224 is one of volatile, non-volatile, fixed, and/or removable storage medium in communication with the processing resource 222 via the electronic bus.

A number of modules (e.g., generate module 228, track module 230, identify module 232, place module 233, distribute module 234, etc.) can include CRI that when executed by the processing resource 222 can perform functions. The number of modules (e.g., generate module 228, track module 230, identify module 232, place module 233, distribute module 234) can be sub-modules of other modules. For example, the generate module 228 and the track module 230 can be sub-modules and/or contained within the same computing device. In another example, the number of modules (e.g., generate module 228, track module 230, identify module 232, place module 233, distribute module 234) can comprise individual modules at separate and distinct locations (e.g., CRM, etc.).

Each of the number of modules (e.g., generate module 228, track module 230, identify module 232, place module 233, distribute module 234) can include instructions that when executed by the processing resource 222 can function as a corresponding engine as described herein. For example, the generate module 228, track module 230, and place module 233 can include instructions that when executed by the processing resource 222 can function as the generate engine 106, the track engine 108, and place engine 112, respectively. In another example, the identify module 232 and the distribute module 234 can include instructions that when executed by the processing resource 222 can function as the identify engine 110.

The generate module 228 can include CRI that when executed by the processing resource 222 can generate an error tracking octree model of a 3-D object to be additively manufactured. As used herein, an octree can include a tree data structure of a 3-D object model created by recursively partitioning the 3-D object model into eight octants. The octree can include the cells resulting from the division where the cells are portions of the partitioned 3-D object model. Each cell can include eight children cells. The cells can correspond to various levels of resolution (e.g., a highest level of resolution corresponding to a single voxel, intermediate levels of resolution corresponding to groups of voxels, a lowest level of resolution corresponding to the entire 3-D object, etc.) of the partitioned 3-D object model as described above. Each cell can contain an amount of error for the corresponding area of the partitioned 3-D object model. The generate module 228 can include CRI that when executed by the processing resource 222 can distribute and track error corresponding to each cell as a portion of generating the error tracking octree model.

The track module 230 can include CRI that when executed by the processing resource 222 can generate an open voxel tracking octree model for the 3-D object. The open voxel tracking octree model can track open voxels within the partitioned 3-D object model. That is, the open voxel tracking octree model can represent a partitioned model of 3-D object characterizing which voxels of the plurality of voxels making up the 3-D object are open/available for deposition of a particular material.

The identify module 232 can include CRI that when executed by the processing resource 222 can identify a plurality of open voxels with respective errors. The open voxels can be identified for placement of a plurality of elements to form at least a portion of the 3-D object. For example, the identify module 232 can include CRI that when executed by the processing resource 222 can randomly inspect the error tracking octree model and/or the open voxel tracking octree model to identify a plurality of voxels which are designated open and designated as containing error within which to place elements forming at least a portion of the 3-D object being modeled.

The place module 233 can include CRI that when executed by the processing resource 222 can place a plurality of elements at the plurality of open voxels to form at least a portion of the 3-D object. The place module 233 can include CRI that when executed by the processing resource 222 can place the elements within the identified voxels. The place module 233 can include CRI that when executed by the processing resource 222 can place elements within open voxels in a manner that enforces connectivity between the placed elements. For example, the place module 233 can include CRI that when executed by the processing resource 222 can place additional elements between adjacent placed elements to create a connection and/or can place elements in a connected manner in the direction of identified voxels.

The distribute module 234 can include CRI that when executed by the processing resource 222 can distribute the placement of the plurality of elements to achieve a particular distribution using a plurality of density-dependent error kernels. For example, the distribute module 234 can include CRI that when executed by the processing resource 222 can create a relative distribution of voxels by using density-dependent error kernels that vary in size to enforce a particular distribution. For example, an error kernel that varies in size based on a target density of a placed element within a voxel can be used to distribute the voxels in a random (e.g., approximately random, semi-random, designed to appear random to a human eye, a non-patterned, etc.) distribution. Additionally, the error kernels can produce a uniform (e.g., approximately uniform, semi-uniform, designed to appear uniform to a human eye, approximately equally spaced, etc.) distribution of placed elements in the 3-D object.

As used herein, an error kernel can include a space filling structure. The error kernel can include a volume of space including voxels of the 3-D object. The error kernel can be an inhibitor with regard to the volume of space and/or voxels included therewith. That is, the error kernel can inhibit the placement of elements at a portion of the voxel within the volume of space. Inhibiting placement can include prohibiting placement of more than a certain number of elements in the voxels within the error kernel, designating certain voxels within the error kernel as open and/or closed, and/or prohibiting placement of an element in certain voxels within the error kernel. The error kernel can be any geometry (e.g., spheres, cubes, etc.) and can scale based on a targeted density fill (e.g., the percentage of voxels of an area targeted to be filled with a placed element). For example, a spherically shaped density-dependent error kernel can have a radius that is based on a principle volume of the placed element to which the error kernel corresponds, as discussed in further detail below in connection with FIG. 3. The error kernels can be used to discourage the overlap of placed materials at prescribed densities by enforcing the aforementioned inhibition. Inhibiting placement of elements within a plurality of the error kernels can create the particular targeted distribution of elements within the 3-D object.

FIG. 3 illustrates an example environment 340 suitable for variable density modeling of a 3-D object according to the present disclosure. The environment is shown to include an input 342, a variable density modeler 344, and a halftoned 3-D object 346.

The environment can include an input 342. The input 342 can be a computer-aided design file for the 3-D structure and/or a conversion thereof to a compatible format. An input 342 can include a 3-D object model. The 3-D object model can be a model of a 3-D variable density object. That is, the 3-D model can be a graphical and/or mathematical representation of a 3-D object to be created via additive manufacturing where the 3-D object has variable target density fills associated with distinct portions or materials thereof. For example, different portions of the 3-D object can have distinct target density fills expressed as a targeted percentage of fill of material of a corresponding area of the 3-D object (e.g., such as a dense 100% fill on an outermost surface of the 3-D object to provide a rigid structure and a sparse/less dense 5% fill of an inner portion of the 3-D object to result in a reduced weight of the 3-D object). The input 342 can be the entire 3-D object or a portion of the entire 3-D object to be additively manufactured.

The environment can include a variable density modeler 344. The variable density modeler 344 can generate a number of tree data structures derived from the input 342. The data structures can be utilized in 3-D halftoning of the input 342. 3-D halftoning of the input 342 can include controlling the distribution of materials in an additive manufacturing process of a 3-D object from the input 342. Halftoning can include simulating a continuous uniform distribution (e.g., continuous tone) through the controlled distribution of “dots” (e.g., placed elements having varied size, shape, and/or spacing) to produce the image. 3-D halftoning can be used to control the distribution of materials in single and/or multi-material 3-D additive manufacturing. 3-D halftoning can be utilized to control color, material properties (e.g., rigidity, texture, density, porosity, etc.), distribution of chemicals or pharmaceutical compounds, distribution of edible flavorings and substances, etc.

The variable density modeler 344 can create an internal or volumetric structure (e.g., halftoned 3-D object model 346) utilizing a 3-D multi-scale error diffusion/halftoning (3MED) formula to distribute discrete elements of material based on a target density of the corresponding portion of the 3-D object being modeled. For example, the input 342 can be a CAD representation of a variable density 3-D mechanical object having an interior region specified at a lower density to indicate porosity or air pockets that give reduced weight or higher rigidity. High wear regions of the object may be specified with a denser fill of a more durable material. For such a variable density 3-D object, fractional densities determined from the CAD input 342 can be converted into discrete units for the additive manufacturing device to produce. Comparatively low density regions of the object can utilize a connected structure to realize a physical manufacture.

Unlike other approaches that employ sequential error diffusion, the 3MED formula can be random access and can utilize a multi-scale error representation to track and/or distribute error for voxels and/or larger regions of the input 342 model. Tracking error can include monitoring error of a corresponding portion of the input 342 model. An error, as described above, can include a probability that a corresponding portion of the input 342 model should receive an element (e.g., have an element placed at the location). The total amount of error (e.g., the total amount of material to be placed) for completion of the halftoning process (e.g., to complete the halftoned 3-D object model) can be predetermined.

The variable density modeler 344 can generate the multi-scale error representation to track and distribute error. The multi-scale error representation can be a tree data structure generated from the input 342. The multi-scale error representation can be an error tracking octree model generated from the input 342. Error can be represented in the error tracking octree model with a voxel-level error at a highest resolution and the sum of the voxel level error stored with increasingly lower resolution in super-voxels (e.g., portions of the 3-D object model including more than a single voxel). For example, the input 342 can be recursively subdivided to form an octree model of the input 342. In this example the smallest cells (e.g. resulting portions of the input 342) resulting from the division can be a voxel-level highest resolution where the octants (or some other portion of the input 342) which were divided to produce those smallest cells can be a lower resolution super-voxel. An error tracking octree model utilizing this structure can contain the voxel-level errors in the cells corresponding to the voxel-level highest resolution and each lower resolution level super-voxel can contain the 2×2×2 sum of the higher resolution cells resulting from its division. The lowest resolution cell/super-voxel can be a cell corresponding to the entire 3-D object model whence the octree was formed and can contain the total amount of error and/or the total amount of material left to place.

In addition, the variable density modeler 344 can track open voxels in a tree data structure. The variable density modeler 344 can generate an open voxel tracking tree data structure. The open voxel tracking tree data structure can be an open voxel tracking octree model. The open voxel tracking octree model can utilize the same or an additional octree model as the error tracking octree model. An open voxel can include a voxel of the voxel tracking octree model that has not yet been assigned a material (e.g., had an element placed). An open voxel can be a voxel available to receive a material. In some examples, an open voxel can be a voxel that is available to receive a particular material or particular materials to the exclusion of other materials. That is, a voxel can be open with respect to certain types of materials.

An open voxel can be distinguished from an empty voxel or a closed voxel. An empty voxel can include a voxel of the voxel tracking octree model that has been assigned and contains atmosphere. A closed voxel can include a voxel that is not available to receive placement of an element. A voxel can be designated as closed whether it already contains a placed element or is an empty voxel.

Tracking open voxels can include tracking which of the voxels in the octree model of the 3-D object is open and/or available for material placement. The open voxel tracking octree model, therefore, can track where an element may potentially be placed. For dispersed dot halftoning, voxels with a target density fill greater than zero can be defined as open. However, in cases where connectivity enforcement is utilized, open voxels can be deterministically opened or closed during execution of the 3MED formula in order to achieve connectivity (e.g., virtual and/or physical connectedness) between the corresponding placed elements.

In producing the halftoned 3-D object model 346, the variable density modeler 344 can search the tree data structures to identify, at each resolution level of the structures, a voxel for placement of an element. For example, cells of the open voxel tracking octree model and/or the error tracking octree model can be randomly examined by the variable density modeler 344 to identify a voxel at each resolution level of the octree that is open with regard to a material being analyzed for placement and has a comparatively large amount of error (e.g., as compared to its neighbors and/or other voxels in the error tracking octree model). Each material being utilized in the creation of the 3-D object can have a separate open voxel tracking octree model and/or the error tracking octree model.

The variable density modeler 344 can place an element in the identified open voxel with the comparatively largest error to form at least a portion of the 3-D object. The variable density modeler 344 can update the open voxel tracking octree model and/or the error tracking octree model to reflect the placement of the element. For example, the variable density modeler 344 can update the open voxel tracking octree model and/or the error tracking octree model to mark the formerly open voxel as closed. As referred to herein, a connected structure utilizing the open voxel tracking octree model can permit or rely on placement of elements adjacent to existing elements in an effort to provide connectivity. For example, during halftoning an open voxel closest to a large error voxel has an element placed and material tendrils can extend out from the placed element into the comparatively high error portions of the 3-D object model and branch to fill to the specified density. The tendrils may change material type as they pass through different portions of the 3-D object model. The 3-D halftoning method can enforce connectivity by making additional connections between material(s) in adjacent voxels.

The variable density modeler 344 can distribute the placement of elements to achieve a particular distribution. The particular distribution can be a seemingly random but uniform dot distribution, or blue noise. The particular distribution can be a relative distribution of voxels distributed using density-dependent error kernels that vary in size to enforce the distribution. The error kernels can function to inhibit placement of elements within a particular volume of the halftoned 3-D object model 346.

In a dispersed dot 3-D halftoning operation each halftoned element can represent a larger volume than itself. For example, at a five percent targeted density fill, each voxel that is placed represents 1 filled voxel and 19 empty voxels to achieve the five percent density fill.

The total volume that each filled voxel in the region represents can be termed a principle volume (Vₚ) and can be derived as:

Vp=1/d

for density fill d. The error kernels can be spherical and sized relative to the radius (rₚ) of the principle volume for that density fill d. For example, the principle wavelength (λ_{z}), or average distance between elements, can be:

$$λ z = 1 / \sqrt[3]{d} .$$

The principle volume Vp, or volume of the output halftoned 3-D object model 346 that each halftoned element represents, can be:

Vp=λ_{z}³

or

Vp=1/d.

That is, a principle volume of a placed element can be equal to an inverse of a target density fill d of a corresponding portion of the 3-D object. For density fill d a spherical error kernel can have a radius rₚ at the principle volume Vp defined as:

$${r}_{p} = {( \frac{3}{4 π d} )}^{1 / 3} .$$

An error kernel can be approximately twice the radius of the principle volume Vp of the corresponding placed element, thus discouraging the overlap of principle volumes for distinct placed material voxels. The error kernel can thereby create a blue-noise distribution in 3-D space. The error kernels can also be used to enforce dependence in element placement and or spacing for different materials.

For each material a corresponding octree model can be searched or otherwise utilized to identify at least one open voxel (e.g., with a comparatively highest error). After placing an element in that open voxel the error kernel can be masked against a corresponding open voxel tracking octree model and renormalized. Error, along with all material's open voxels can be updated through the octree. The process can repeat until all material elements have been placed.

Error can be distributed to open voxels within the 3-D object model. However, at some portions of the 3-D object model (e.g., object shells, surfaces, etc.) the error kernel corresponding to a voxel with a placed element may not encompass the desired volume of open voxels. In such instances the radius of the error kernel can be adaptively expanded to achieve the consistent distribution of material. This can be accomplished by masking the portions of the error kernel sphere that are outside the 3-D object model so that the sphere becomes a disc at the surface and its corresponding voxel volume is spread in two dimensions. That is, the error kernel is adaptively sized to the intersected principle volume.

The variable density modeler 344 can repeat the some or all of the actions described above until all material elements have been placed to form a 3-D object model. The variable density modeler 344 can thereafter output the halftoned 3-D object model 346. The 3-D object model can be utilized as a map suitable to additively manufacture a physical replica of the 3-D object (e.g., via a 3-D printer).

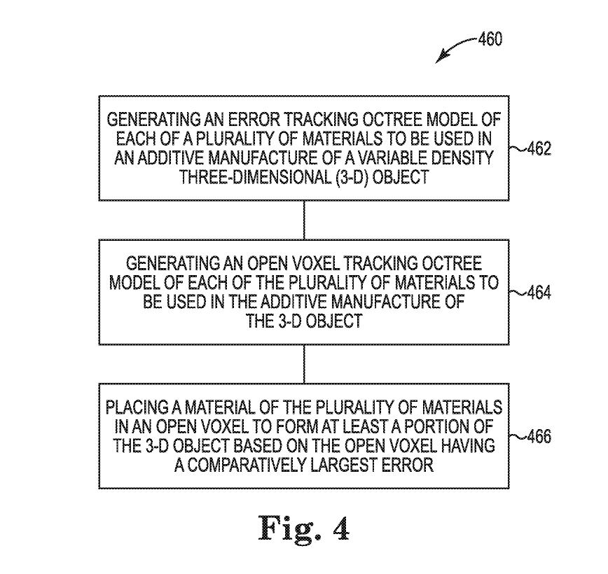

FIG. 4 illustrates a flow chart of an example of a method 460 for variable density modeling utilizing a plurality of materials. The method 460 can generate an error tracking octree model of a 3-D object that is additively manufactured, generate an open voxel tracking octree model for each of the plurality of materials used in the additive manufacture of the 3-D object, and identify an open voxel for placement of a material of the plurality of materials to form at least a portion of the 3-D object based on the open voxel having a comparatively largest error. In some examples, the method 460 can be performed utilizing a system (e.g., system 100 as referenced in FIG. 1) and/or a computing device (e.g., computing device 220 as referenced in FIG. 2).

As illustrated at 462, the method 460 can include generating an error tracking octree model for each of a plurality of materials used in an additive manufacture of a variable density three-dimensional (3-D) object. The error tracking octree model can be used to track and distribute error across voxels in a 3-D object model. The plurality of materials used in an additive manufacture of a variable density three-dimensional (3-D) object can be halftoned together to produce a full fill of the error tracking octree model. Each voxel of the error tracking octree model can have multiple material densities associated with it (e.g., may contain a material volume coverage (Mvoc) vector defining the proportion of the volume occupied by available materials and/or colorants. Further, the plurality of materials can each have respective target fill densities of a particular voxel and/or the entire 3-D object model.

As illustrated at 464, the method 460 can include generating an open voxel tracking octree model for each of the plurality of materials used in the additive manufacture of the 3-D object. The open voxel tracking octree model can be used to identify open voxels in the 3-D object model in addition to identifying which of the open voxels are able to receive placement of particular materials of the plurality of materials.

As illustrated at 466, the method 460 can include placing a material of the plurality of materials in an open voxel to form at least a portion of the 3-D object based on the open voxel having a comparatively largest error. Additionally, the method 460 can include identifying an open voxel for placement of a material of the plurality of materials to form at least a portion of the 3-D object based on the open voxel having a comparatively largest error and having a designation of availability for placement of the particular material of the plurality of materials.

The method 460 can further include placing a material in the identified open voxel. In some examples the method 460 can include, closing and/or designating as filled the identified open voxel in the open voxel tracking octree model upon placement of the material the voxel. In further examples, this can include closing the open voxel to placement of a different material/element (e.g., a secondary material/element) upon placement of the material.

Alternatively, the method 460 can include opening, leaving open, and/or designating available to receive, upon placement of the material, the identified open voxel for placement of a different material/element. That is, placing an element in a voxel can result in that voxel being designated to receive a secondary material. For example, the placed material can be a receptive material. A receptive material can be a material that is physically suitable to receive a secondary material. For example, a receptive material can include a porous material that can house a secondary material within it pores (e.g., a timed release structure that can house a pharmaceutical compound within it so that the release of the pharmaceutical is controlled). The receptive material can also include a chemical that when in proximity to the secondary chemical will exhibit targeted alterations of physical properties and/or undergo a specific chemical reaction. Each of the plurality of materials can be different materials and/or have different target fill densities in one or more examples.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor. Further, as used herein, “a” or “a number of” something can refer to one or more such things. For example, “a number of widgets” can refer to one or more widgets.

The figures herein follow a numbering convention in which the first digit or digits correspond to the drawing figure number and the remaining digits identify an element or component in the drawing. As will be appreciated, elements shown in the various examples herein can be added, exchanged, and/or eliminated so as to provide a number of additional examples of the present disclosure. In addition, as will be appreciated, the proportion and the relative scale of the elements provided in the figures are intended to illustrate certain examples of the present disclosure, and should not be taken in a limiting sense.

The above specification, examples and data provide a description of the method and applications, and use of the system and method of the present disclosure. Since many examples can be made without departing from the spirit and scope of the system and method of the present disclosure, this specification merely sets forth some of the many possible example configurations and implementations.

What is claimed is:

1. A system of variable density modeling, comprising:
a generate engine to generate an error tracking octree model of a variable density three-dimensional (3-D) object to be additively manufactured;
a track engine to generate an open voxel tracking octree model of the 3-D object; and
an identify engine to identify an open voxel with a comparatively largest error.

2. The system of claim 1, including a place engine to place an element in the open voxel to form at least a portion of the 3-D object and update the error tracking octree model and the open voxel tracking octree model to mark the open voxel as closed.

3. The system of claim 2, including an open engine to open a voxel adjacent to the placed element to enforce connectivity.

4. The system of claim 1, wherein a cell of a plurality of highest-resolution cells of the error tracking octree model has a single voxel-level error resolution.

5. The system of claim 4, wherein a lowest resolution cell of the error tracking octree model contains the plurality of highest-resolution cells and models a total amount of material remaining to be placed of the 3-D object as a sum of the remaining errors of the plurality of highest-resolution cells.

6. The system of claim 1, wherein a voxel with a target density fill greater than zero in the open voxel tracking octree model is identified as an open voxel.

7. A non-transitory computer readable medium storing instructions executable by a processing resource to cause a computer to:
generate an error tracking octree model of a three-dimensional (3-D) object to be additively manufactured;
generate an open voxel tracking octree model of the 3-D object;
identify a plurality of open voxels with respective errors;
place a plurality of elements at the plurality of open voxels to form at least a portion of the 3-D object; and
distribute the placement of the plurality of elements to achieve a particular distribution using a plurality of density-dependent error kernels.

8. The non-transitory computer readable medium of claim 7, wherein a principle volume of a placed element is equal to an inverse of a target density fill of a corresponding portion of the 3-D object.

9. The non-transitory computer readable medium of claim 8, wherein the plurality of density-dependent error kernels includes a density dependent error kernel that has a spherical shape.

10. The non-transitory computer readable medium of claim 9, wherein the spherically shaped density-dependent error kernel has a radius that based on a principle volume of a corresponding placed element.

11. The non-transitory computer readable medium of claim 7, wherein a mask is applied to a portion of a density-dependent error kernel of the plurality of density-dependent error kernels that is outside of the 3-D object.

12. A method of variable density modeling, comprising:
generating an error tracking octree model of each of a plurality of materials to be used in an additive manufacture of a variable density three-dimensional (3-D) object;
generating an open voxel tracking octree model of each of the plurality of materials to be used in the additive manufacture of the 3-D object; and
placing a material of the plurality of materials in an open voxel to form at least a portion of the 3-D object based on the open voxel having a comparatively largest error.

13. The method of claim 12, including closing the open voxel upon placement of the material.

14. The method of claim 12, including opening the identified open voxel to placement of a different material upon placement of the material.

15. The method of claim 12, wherein the plurality of materials each have respective target fill densities.
